(19) United States
(12) Patent Application Publication
(10) Pub. No.: US 2026/0002777 A1
(43) Pub. Date: Jan. 1, 2026

(54) METHOD FOR DETECTING A FREE PLAY IN A CONTROL SURFACE AND ASSOCIATED DETECTION SYSTEM

(71) Applicant: DASSAULT AVIATION, Paris (FR)

(72) Inventors: Jean GAUTHIER, Saint-Cloud Cedex (FR); Jean Dominique Thouvenin, Saint -Cloud Cedex (FR); Vincent Lalauze, Istres Cedex (FR)

(21) Appl. No.: 19/249,874

(22) Filed: Jun. 25, 2025

(30) Foreign Application Priority Data
Jun. 28, 2024 (FR) FR 24 07051

(51) Int. Cl. G01B 21/16; B64C 13/40; F15B 19/00

(52) U.S. Cl. CPC G01B 21/16; B64C 13/40; F15B 19/00; F15B 2211/6656

(57) ABSTRACT

A method for detecting play in a control surface and associated detection system which is including an aerodynamic control system, the control system including a fixed part, a movable control surface, and two servo-control blocks to cause a movement of the control surface. The method includes a play detection sequence including a command phase and a play detection phase. The command phase includes the asymmetric command of the servo-control blocks and the acquisition of an evolution, during the asymmetric command, of a force variable representative of an antagonistic force exerted in one of the servo-control blocks during the asymmetric command. The play detection phase includes the verification of a play detection condition based on the acquired evolution.

### TECHNICAL FIELD

This present disclosure relates to a method for detecting play in an aerodynamic control system, the aerodynamic control system comprising a fixed part, a movable control surface relative to the fixed part, and a servo-control, the servo-control comprising at least two redundant servo-control blocks, each servo-control block being configured for causing a movement of the control surface relative to the fixed part.

### BACKGROUND

The present disclosure applies to any control surface and in particular to any control surface of an aircraft, the aircraft being e.g. a civil aviation aircraft, notably a business aviation aircraft.

The servo-control typically corresponds to an actuator configured to control the orientation of a movable surface via a mechanical chain. The change in orientation of the movable surface generates an aerodynamic force that allows the orientation of the aircraft to be controlled according to the pitch, roll, and/or yaw axis thereof. Such a change in orientation can also serve in the function of high-lift devices and/or airbrakes.

The mechanical chain of such a control surface comprises a number of screws, bolts, actuators, and other parts. Each of these parts may exhibit mechanical play. These plays can be, e.g., the result of mechanical wear at these parts (e.g. fastening(s), rod(s), or hinge(s)). These mechanical plays accumulate to form a total mechanical play for the control surface.

This total mechanical play is characterized by a capacity for free movement of the control surface without any commanded movement.

In the field of civil aviation in particular, it becomes necessary to demonstrate that the value of this total mechanical play is hereinbelow a threshold value. This requirement must be met in production for a new aircraft and during subsequent service-life thereof in the form of scheduled maintenance. This total mechanical play must therefore be determined or estimated.

It is known to check the total mechanical play according to a conventional method. In this method, a rigid dummy actuator is installed in place of the hydraulic servo-control used in nominal operation. A predefined torque is applied to the trailing edge of the movable surface in each direction, the torque being measured by strain gauges and recorded. The displacement of the surface is measured with a laser sensor and recorded. The total mechanical play is then deduced from the comparison of the applied torque and the measured displacement.

However, this method is not fully satisfactory.

### SUMMARY

In particular, this method is long and expensive. Moreover, due to human safety rules, all hydraulic servo-controls must be removed from the aircraft to prevent the operator from performing the verification thereof on an aircraft wherein hydraulic pressure is activated. Furthermore, in maintenance, checks must be carried out by a specialized engineer specifically trained for this purpose, and with specific tooling that is heavy and cumbersome.

A goal of the present disclosure is therefore to propose a method for detecting the presence of play in the mechanical control chain of an aircraft control surface, which is simple to implement, reliable, sufficiently precise, safe, and quick.

Moreover, an additional goal of the present disclosure is that this method can on-board and integrated into the aircraft and can be automated.

To this end, the present disclosure relates to a method for detecting play of the aforementioned type wherein the method comprises a play detection sequence comprising at least one command phase and one play detection phase,
the command phase comprising:
the asymmetric command of the servo-control blocks, during which a first of the servo-control blocks is commanded to cause a movement of the control surface relative to the fixed part, while the second of the servo-control blocks is commanded differently;
the acquisition of an evolution, during said asymmetric command, of a force variable representative of an antagonistic force exerted in one of the servo-control blocks during said asymmetric command;
the play detection phase comprising the verification of at least one play detection condition based on said acquired evolution, said play being detected if the detection condition is met.

According to other advantageous aspects of the present disclosure, the method comprises one or a plurality of the following features, taken in isolation or according to all technically possible combinations:
during the asymmetric command, the second of the servo-control blocks is commanded to maintain the control surface in position relative to the fixed part;
the command phase further comprises, for each of a predetermined number of measurement points of the aerodynamic control system, the acquisition of at least one evolution of a displacement of the measurement point during said asymmetric command, and, wherein the play detection phase comprises, for each measurement point, the verification of a detection condition associated with the measurement point, the verification comprising:
the determination of a displacement amplitude of said measurement point, reached during the acquired evolution of said displacement of the measurement point;
the determination of a reference amplitude associated with said measurement point, the reference amplitude being determined at least based on the acquired evolution of the force variable, and
the comparison of the displacement amplitude of said measurement point with the reference amplitude, the play detection condition being met at least if the difference between the displacement amplitude of said measurement point and the reference amplitude is greater than a predetermined play detection threshold;
the reference amplitude is determined from at least one reference value of the force variable, the reference value being representative of a predetermined antagonistic force exerted during the asymmetric command;
the reference amplitude is further determined based on an equivalent reference stiffness associated with said measurement point, the equivalent reference stiffness corresponding to an absence of play; the equivalent reference stiffness having preferably been previously determined for an absence of play, following a preliminary parameterization phase for a proven absence of play in the aerodynamic control system, the preliminary parameterization phase preferably comprising the same command phases as the implemented detection sequence;
each servo-control block respectively comprises at least one servomotor, a body, and a sliding element relative to the body, the sliding element comprising a rod extending longitudinally to an end connected to the control surface; and, for each servo-control block, a controller being configured for commanding the servomotor by closed-loop control to cause a movement of the control surface relative to the fixed part by moving the sliding element relative to the body to a closed-loop control setpoint position;
the force variable depends on the closed-loop control of the servomotor by the controller of the servo-control block during the asymmetric command;
during the asymmetric command, the first of the servo-control blocks is commanded to cause a movement of the control surface relative to the fixed part by moving the sliding element relative to the body according to at least one cycle of extension and retraction of the sliding element relative to the body;
each cycle of extension and retraction comprises, from a neutral position, the extension or retraction of the sliding element to a first extreme position, then the retraction or extension to a second extreme position, then the return to the neutral position, the neutral position preferably corresponding to the position at which the sliding element of the second servo-control block is maintained, the neutral position being preferably disposed between the first extreme position and the second extreme position;
the determination of the reference amplitude comprises the determination of at least two reference values of the force variable, the reference values being defined as the values reached by the variable at the first extreme position and at the second extreme position of the displacement cycle, the reference amplitude being determined from said reference values;
the measurement point of the aerodynamic control system is a point of the control surface, the displacement of said measurement point being relative to the fixed part; or the measurement point of the aerodynamic control system is a point of the sliding element of one of the servo-control blocks, the displacement of said measurement point being relative to the body;
the predetermined number of measurement points of the aerodynamic control system is greater than or equal to four, the measurement points comprising:
a point of the sliding element of the first of the servo-control blocks,
a point of the sliding element of the second of the servo-control blocks,
a first point of the control surface, the first point being disposed closer to the rod of the first of the servo-control blocks than to the rod of the second of the servo-control blocks, and
a second point of the control surface, the second point being disposed closer to the rod of the second of the servo-control blocks than to the rod of the first of the servo-control blocks;
said command phase is a first command phase, the play detection sequence also comprising a second inverted command phase, comprising:
the asymmetric command of the servo-control blocks, during which the second of the servo-control blocks is commanded like the first of the servo-control blocks during the asymmetric command of the first phase, and the first of the servo-control blocks is commanded like the second of the servo-control blocks during the asymmetric command of the first phase;
the acquisition of an evolution, during said asymmetric command, of a force variable representative of an antagonistic force exerted in one of the servo-control blocks during said asymmetric command;
and, wherein the play detection phase comprises, for each implemented command phase, the verification of at least one detection condition based on said acquired evolution during the command phase;
each servo-control block is hydraulic, and, for each servo-control block, the body defines an internal space and the sliding element also comprises a control piston disposed in the internal space, the internal space being shared by the control piston between an extension chamber and a retraction chamber, the servomotor of each servo-control block comprising a hydraulic distributor to route a fluid from a fluid source to the extension chamber and/or to the retraction chamber, the controller being configured for commanding the hydraulic distributor of the servomotor to cause a movement of the sliding element relative to the body, and, wherein the force variable is a function of the measured pressures of the extension chamber and the retraction chamber of the servo-control block;
the detection condition is met at least if said acquired evolution of the force variable presents a region where the force variable is representative of a stress force exerted on one of the servo-control blocks by the control surface which is zero during said asymmetric command, the region preferably having an extent greater than a predetermined play detection threshold.

The present disclosure also relates to a system for detecting play in an aerodynamic control system, the aerodynamic control system comprising a fixed part, a movable control surface relative to the fixed part, and a servo-control, the servo-control comprising two redundant servo-control blocks, each servo-control block being configured for causing a movement of the control surface relative to the fixed part;
characterized in that the detection system comprises a control unit configured to independently command each servo-control block and to implement a play detection sequence comprising at least one command phase and one play detection phase,
the command phase comprising:
the asymmetric command of the servo-control blocks, during which a first of the servo-control blocks is commanded to cause a movement of the control surface relative to the fixed part, while the second of the servo-control blocks is commanded differently;
the acquisition of an evolution, during said asymmetric command, of a force variable representative of an antagonistic force exerted in one of the servo-control blocks during said asymmetric command;
the play detection phase comprising the verification of at least one detection condition based on said acquired evolution, play being detected if the detection condition is met.

### BRIEF SUMMARY OF THE DRAWINGS

The present disclosure will become clearer upon reading the following description, given solely by way of non-limiting example, and made with reference to the drawings wherein:

FIG. 1 is a schematic sectional view of a detection system and an aircraft control surface concerned by the present disclosure;

FIGS. 2 and 3 are schematic views of the control surface during a detection method of the present disclosure;

FIG. 4 corresponds to a schematic flowchart of a method according to the present disclosure; and

FIGS. 5 and 6 are schematic views of examples of evolution curves acquired during the detection method.

### DETAILED DESCRIPTION

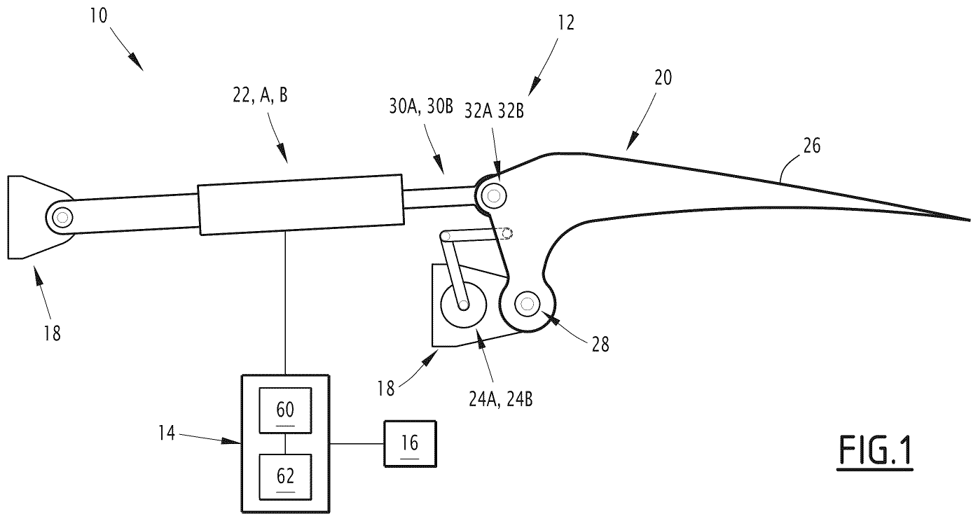

A detection system 10 for play in an aerodynamic control system 12, e.g. of an aircraft, is shown in FIG. 1.

The detection system 10 thus comprises the aerodynamic control system 12 and a control unit 14 configured to implement a play detection sequence 102.

The detection system 10 also comprises a sensor system 16 for implementing the play detection sequence 102.

The aerodynamic control system 12 comprises a fixed part 18, a control surface 20, movable relative to the fixed part 18, and a servo-control 22, the servo-control 22 comprising at least two redundant servo-control blocks A and B.

The aerodynamic control system 12 also preferably comprises at least two displacement sensors 24A, 24B of the control surface 20 relative to the fixed part 18.

The fixed part 18 is fixed in particular relative to a structure of the aircraft.

In the example of FIG. 1, the control surface 20 is a flaperon. Alternatively, the control surface 20 is of any conceivable type, e.g. an aileron, a rudder, an elevator, a high-lift device, an airbrake, or any other control surface driven by an actuator.

The control surface 20 is in contact with an air mass external to the aircraft. It has a surface 26 whose displacement, e.g. a change in orientation, relative to said fixed part 18 generates a change in an aerodynamic force.

The control surface 20 is e.g. configured so that said surface 26 allows the orientation of the aircraft to be controlled according to the pitch, roll, and/or yaw axis thereof.

The control surface 20 is typically movable in rotation relative to the fixed part 18 between at least two positions, one of which is shown in FIG. 1.

The control surface 20 then has at least one articulation 28 with the fixed part 18.

The control surface 20 is e.g. formed of a rigid assembly of a plurality of parts fixed to each other.

The displacement sensors 24A, 24B are configured for measuring the displacement, relative to the fixed part 18, of two respective measurement points of the control surface 20.

The displacement sensors 24A, 24B are on-board and integrated in a non-retractable manner in the aerodynamic control system 12. These sensors 24A, 24B are therefore not specifically added to implement the method. The sensors 24A, 24B are the functional sensors necessary for piloting the control surface 20 under nominal use conditions during flight.

The displacement sensors 24A, 24B are placed e.g. in the vicinity of the servo-control 22.

The measurement points comprise in particular a first point of the control surface 20, the first point being disposed closer to a first of the servo-control blocks B than to a second of the servo-control blocks A (sensor 24B), and a second point of the control surface 20, the second point being disposed closer to the second of the servo-control blocks A than to the first of the servo-control blocks B (sensor 24A).

The sensors 24A and 24B translate e.g. two measurement points of the control surface 20 on each side of the servo-control 22.

The displacement sensors 24A, 24B are e.g. of the SSU type (“Secondary Sensor Unit”). Any other sensor can be considered within the scope of the present disclosure.

The servo-control 22 is configured to cause a movement of the control surface 20 relative to the fixed part 18, via a mechanical chain 30A, 30B per servo-control block 22A, 22B.

Each mechanical chain 30A, 30B comprises a plurality of assembly members, such as fasteners (screws and/or bolts), cranks, and/or bearings.

The servo-control 22 is advantageously connected to an onboard flight control system of the aircraft.

The onboard flight control system of the aircraft is then configured for commanding the servo-control 22, e.g. during flight. In particular, during flight, a pilot of the aircraft is configured for commanding the servo-control 22 via the flight control system.

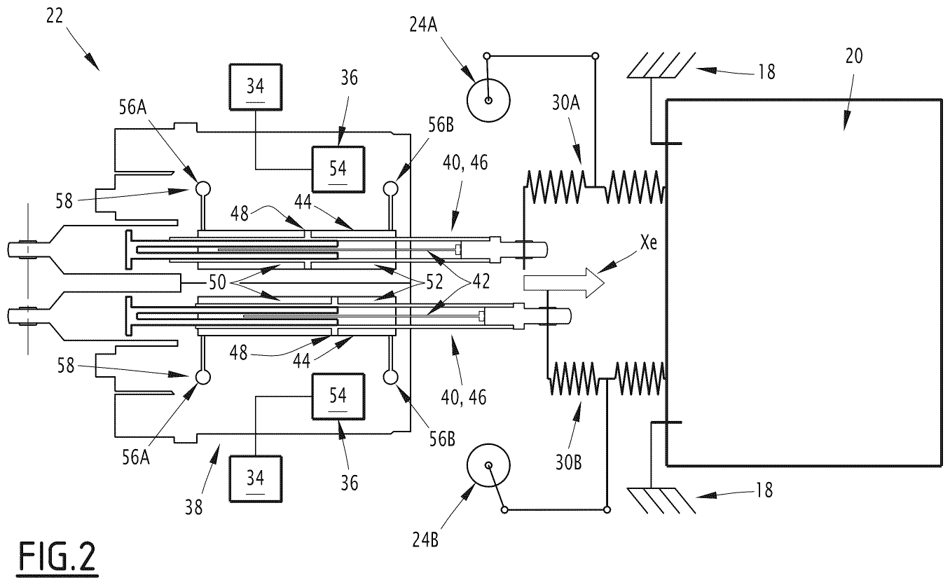

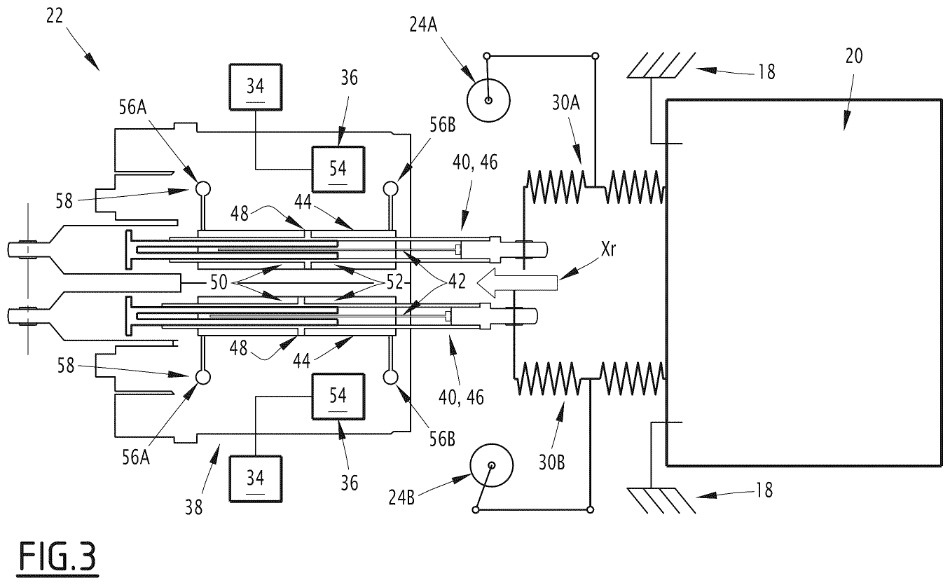

In the example shown in FIGS. 2 and 3, the servo-control 22 comprises only two redundant servo-control blocks A, B.

Each servo-control block A, B is configured for causing a movement of the control surface 20 relative to the fixed part 18.

In nominal operation of the aerodynamic control system 12, e.g. during flight of the aircraft, the redundant servo-control blocks A, B are configured for being commanded jointly and identically, e.g. by the flight control system of the aircraft.

The mechanical chains 30A, 30B of the two redundant servo-control blocks A, B are connected to the control surface 20 at two connection points 32A, 32B of the control surface 20.

The two connection points 32A, 32B are fixed in position relative to the control surface 20 during any movement of the control surface 20 relative to the fixed part 18.

The two connection points 32A, 32B are e.g. disposed between the two measurement points of the displacement sensors 24A, 24B of the aerodynamic control system 12.

Each servo-control block A, B respectively comprises at least one servomotor 36, a body 38, and a sliding element 40 relative to the body 38.

The aerodynamic control system 12 also comprises, for each servo-control block A, B, a controller 34 of the servo-control block. The controller 34 is e.g. included in the onboard flight control system of the aircraft.

Each servo-control block A, B also comprises a sensor 42 for the position of the sliding element 40 relative to the body 38.

In a first embodiment, referred to as hydraulic hereinafter and shown in FIGS. 2 and 3, each servo-control block A, B is hydraulic.

The body 38 is preferably integral with the fixed part 18.

In particular, the body 38 is articulated with the fixed part 18.

The body 38 remains e.g. immobile relative to the fixed part 18 during any movement of the control surface 20 relative to the fixed part 18.

The body 38 defines an internal space 44, wherein the sliding element 40 is configured for moving between a fully retracted position and a fully deployed position.

The fully retracted and fully deployed positions are defined as the most extreme positions achievable by the sliding element 40. In particular, the sliding element 40 is e.g. in abutment in each of these positions.

The sliding element 40 is movable relative to the body 38, e.g. rectilinearly in a longitudinal direction.

The sliding element 40 preferably comprises a rod 46 extending longitudinally to an end connected to the mechanical chain 30A, 30B.

In the example shown in FIGS. 2 and 3, the rod 46 is hollow. The hollow part is elongated longitudinally.

In the first hydraulic embodiment, the sliding element 40 also comprises a control piston 48 disposed in the internal space 44 of the body 38.

The internal space 44 is then shared in a leak-tight manner by the control piston 48 between an extension chamber 50 and a retraction chamber 52.

The servomotor 36 is configured for providing the mechanical energy to cause the movement of the sliding element 40 relative to the body 38.

In the first hydraulic embodiment, the servomotor 36 is then hydraulic.

The servomotor 36 comprises e.g. a hydraulic distributor 54 configured for routing a fluid from a fluid source to the extension chamber and/or to the retraction chamber 52, and vice versa.

The fluid is e.g. a gas or a liquid.

The fluid source is then e.g. the hydraulic circuit of the aircraft. The fluid source then delivers a pressure, e.g. constant, to the hydraulic distributor 54.

The hydraulic distributor 54 preferably comprises at least one pressure sensor 56A, 56B of at least one of the chambers 50, 52. Advantageously, the hydraulic distributor 54 comprises a pressure sensor 56A of the extension chamber 50 and another pressure sensor 56B of the retraction chamber 52.

The pressure sensors 56A, 56B are not functionally used during flight of the aircraft. The pressure sensors 56A, 56B are typically used only during reliability tests before departure or in maintenance to make adjustments to the servo-control 22.

The position sensor 42 is configured for acquiring a current position of a measurement point of the sliding element 40 relative to the body 38. The measurement point is a point of the rod 46.

The position sensor 42 is integral on the one hand with the body 38 and on the other hand with the measurement point of the rod 46.

The position sensor 42 comprises e.g. an LVDT sensor (Linear Variable Differential Transformer). Any other type of position sensor known to those skilled in the art is conceivable within the scope of the present disclosure.

In the example of FIGS. 2 and 3, the position sensor 42 is disposed inside the hollow part of the rod 46.

The controller 34 is e.g. implemented as a programmable logic component, such as an FPGA (Field Programmable Gate Array), or as an integrated circuit, such as an ASIC (Application Specific Integrated Circuit). Alternatively, the controller 34 is e.g. implemented as one or a plurality of softwares, i.e., as a computer program, it is also configured for being recorded on a medium, not shown, readable by a computer. The computer-readable medium is e.g. a medium configured for storing electronic instructions and being coupled to a bus of a computer system. For example, the readable medium is an optical disk, a magneto-optical disk, a ROM memory, a RAM memory, any type of non-volatile memory (e.g. FLASH or NVRAM), or a magnetic card. On the readable medium a computer program comprising software instructions is then stored.

The controller 34 is configured for commanding the servomotor 36 by closed-loop servo-control to cause a movement of the control surface 20 relative to the fixed part 18 by moving the sliding element 40 relative to the body 38, to a servo-control setpoint position.

During closed-loop control, the controller 34 is configured for comparing the servo-control setpoint position to the current position of the sliding element 40, acquired by the position sensor 42, and commanding the servomotor 36 to correct the possible difference until reaching and maintaining the sliding element 40 at the servo-control setpoint position.

The sliding element 40 is thus maintained at the servo-control setpoint position by the servomotor 36, once said position is reached.

In the first hydraulic embodiment, the controller 34 is configured for commanding the hydraulic distributor 54 of the servomotor 36 to cause a movement of the sliding element 40 relative to the body 38.

In particular, the controller 34 is configured for commanding the hydraulic distributor 54 of the servomotor 36 to supply the extension chamber 50 to cause an extension of the sliding element 40 towards the fully deployed position, or to supply the retraction chamber 52 to cause a retraction of the sliding element 40 towards the fully retracted position.

The pressure sensors 56A, 56B are not used functionally during the position servo-control. In other words, the pressures measured by the pressure sensors 56A, 56B are not used in the servo-control loop to move the sliding element 40 to the servo-control setpoint position.

The sensor system 16 of the detection system 10 takes part in the implementation of the detection sequence 102.

Preferably, the sensor system 16 comprises at least one force sensor 58, configured for acquiring a force variable representative of an antagonistic force exerted in one of the servo-control blocks A, B during said asymmetric command, as described hereinbelow.

Advantageously, the sensor system 16 comprises a force sensor 58 for each of the servo-control blocks A, B. Each force sensor 58 measures a force variable representative of the antagonistic force exerted in the associated block A, B.

In the first hydraulic embodiment, for each servo-control block A, B, the force sensor 58 advantageously corresponds to the assembly formed by the pressure sensor 56A of the extension chamber 50 and the pressure sensor 56B of the retraction chamber 52 of the associated servo-control block A, B.

The sensor system 16 also comprises e.g., for each servo-control block A, B, said position sensor 42 of the sliding element 40.

Furthermore, the sensor system 16 comprises e.g. at least two displacement sensors of the control surface 20 relative to the fixed part 18. These are preferably the integrated displacement sensors 24A, 24B.

Thereby, in such a preferred embodiment, the entire sensor system 16 is integrated in a non-retractable manner into the aerodynamic control system 12. The entire sensor system 16 is particularly formed by sensors used during the nominal operation of the aerodynamic control system during flight.

In a variant, at least one or each of the displacement sensors of the sensor system 16 of the detection system 10 is not one of the displacement sensors 24A, 24B integrated into the aerodynamic control system 12. At least one of said displacement sensors of the sensor system 16 is then a sensor external to the aerodynamic control system 12 and particularly external to the aircraft. Such an external sensor is e.g. a laser sensor, such a sensor being known to a person skilled in the art.

The control unit 14 is configured for implementing a play detection sequence 102 which will be described hereinbelow.

To do this, the control unit 14 comprises e.g. a computer processing device 60 operationally connected to a computer memory 62, e.g., a digital signal processor (DSP), a microcontroller, a programmable cell network (FPGA Field Programmable Gate Array) and/or a dedicated integrated circuit (ASIC Application Specific Integrated Circuit) configured for executing various data processing operations and functions, particularly at least the detection sequence 102 described hereinbelow.

The computer processing device 60 comprises e.g. a single processor. Alternatively, the computer processing device 60 comprises several processors, which are located in the same geographical area, or are, at least partially, located in different geographical areas and are then configured for communicating with each other.

By the term “memory”, we mean any volatile or non-volatile computer memory appropriate to the subject currently disclosed, such as a random access memory (RAM), a read-only memory (ROM), or other electronic, optical, magnetic, or any other computer-readable storage medium on which the data and control functions as described here are stored.

Consequently, the memory 62 is a tangible storage medium where the data and control functions are stored in a non-transitory form.

In one embodiment, the control unit 14 is on-board and integrated in a non-retractable manner into the aircraft. The control unit 14 is e.g. then configured for also commanding the servo-control 22 in nominal operation of the aircraft, e.g. during flight of the aircraft. The control unit 14 is e.g. in this case comprised in the onboard flight control system of the aircraft. An operator of the aircraft is configured for triggering the play detection sequence 102, e.g. via a human-machine interface.

The control unit 14 is configured for inhibiting the triggering of the play detection sequence if the aircraft is in flight or during ground maneuvering.

Alternatively, the control unit 14 is retractable relative to the aircraft and therefore dissociated from the aircraft. The control unit 14 is then e.g. comprised in a test bench connectable in a removable manner to the servo-control 22.

The control unit 14 is configured to independently command each servo-control block A, B.

More precisely, the control unit 14 is configured to send a control signal, e.g. a servo-control setpoint position, to the controller 34 of each servo-control block A, B, independently.

The control unit 14 is configured for sending different control signals to the controllers 34 of the two servo-control blocks A, B, the signals then commanding two distinct servo-controls, e.g. two distinct servo-control setpoint positions.

The control unit 14 is also connected to the sensor system 16 to acquire the evolution of the various measurements made over time by the sensors of the sensor system 16, as will be described in more detail hereinbelow.

A method 100 for detecting play according to the present disclosure will now be described with reference to FIGS. 2 to 6.

The method 100 for detecting play comprises a play detection sequence 102 comprising at least one command phase 104A, 104B, and a play detection phase 106.

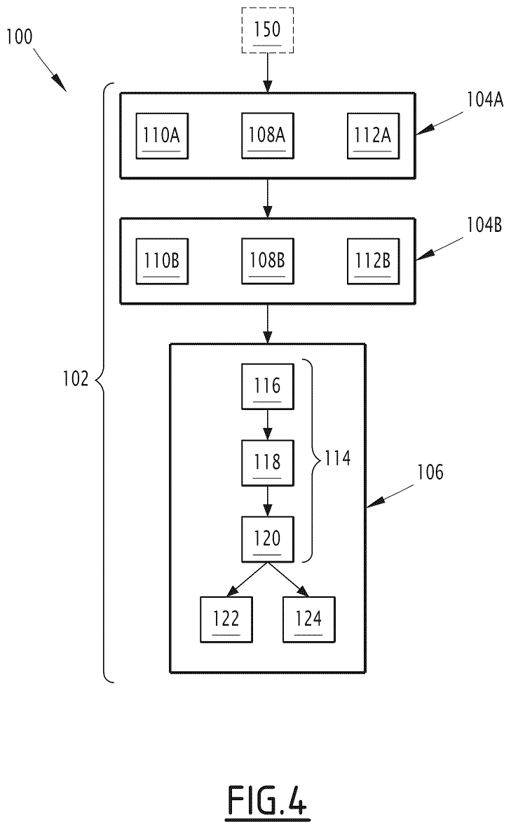

In a preferred embodiment, shown in FIG. 4, the command phase is repeated in an inverted manner. In particular, said command phase 104A is a first command phase, the play detection sequence 102 also comprising a second inverted command phase 104B.

The play detection sequence 102 is preferably implemented by the control unit 14.

The first command phase 104A will now be described.

The first command phase 104A comprises at least the asymmetric command 108A of the servo-control blocks A, B.

During the asymmetric command 108A, a first of the servo-control blocks B is commanded to cause a movement of the control surface 20 relative to the fixed part 18, while the second of the servo-control blocks A is commanded differently.

During the asymmetric command 108A, the control unit 14 thus sends different control signals to the controllers 34 of the two servo-control blocks A, B. The control signals then command two distinct servo-controls.

In the preferred example shown in FIGS. 2 and 3, during the asymmetric command 108A, the second of the servo-control blocks A is commanded to maintain the control surface 20 in position relative to the fixed part 18.

More precisely, during the asymmetric command 108A, the controller 34 of the first servo-control block B is then commanded to command the servomotor 36 by closed-loop servo-control to cause a movement of the sliding element 40 relative to the body 38, while the controller 34 of the second of the servo-control blocks A is commanded to command the servomotor 36 by closed-loop servo-control to maintain the sliding element 40 in a predetermined servo-control setpoint position relative to the body 38.

Advantageously, as shown in FIGS. 2 and 3, during the asymmetric command 108A, the first of the servo-control blocks B is commanded to cause the movement of the control surface 20 relative to the fixed part 18 by moving the sliding element 40 relative to the body 38 according to at least one cycle of extension and retraction of the sliding element 40 relative to the body 38.

Said movement of the sliding element 40 relative to the body 38 comprises e.g. a single cycle or a plurality of cycles, the cycles then being preferably identical.

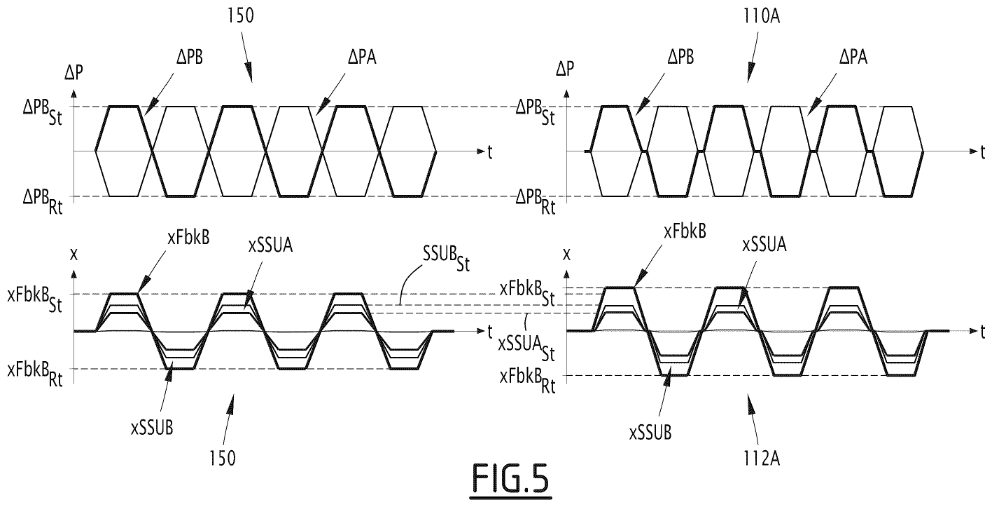

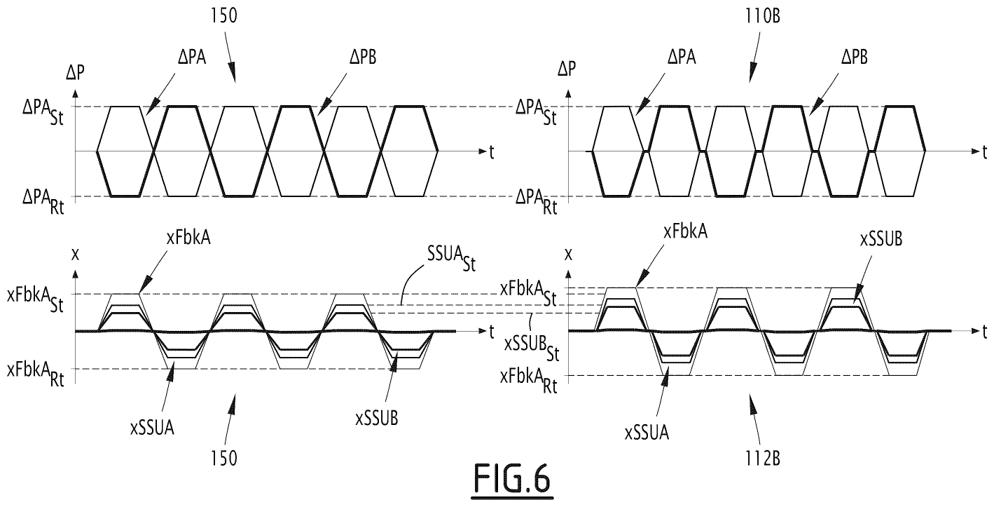

An example of a cycle is shown in FIGS. 5 and 6.

Each cycle of extension and retraction comprises, from a neutral position, the extension (illustrated by the arrow Xe in FIG. 3) or the retraction of the sliding element 40 to a first extreme position, then the retraction (illustrated by the arrow Xr in FIG. 4) or the extension to a second extreme position, then the return to the neutral position.

Preferably, the first extreme position and the second extreme position are determined based on the force variable described in more detail hereinbelow.

More precisely, the control unit 14 is configured to monitor the force variable during the cycle (as indicated hereinbelow), and to stop the movement of the sliding element 40 at said extreme positions, when the force variable is representative of an antagonistic force exerted above a predetermined force threshold.

The predetermined force threshold is chosen not to cause damage to the blocks A, B and to be repeatable for several cycles.

Thereby, the extreme positions of the cycle do not necessarily correspond to the fully retracted and fully deployed positions achievable by the sliding element 40, but rather correspond to the positions where the antagonistic force exerted exceeds the predetermined threshold.

Each cycle preferably comprises a plateau at the first extreme position and a plateau at the second extreme position, the plateaus being e.g. of the same duration, the duration being preferably non-zero.

During the cycle, the transition from the first extreme position to the second extreme position is made without stopping at the neutral position.

The neutral position preferably corresponds to the position at which the sliding element 40 of the second servo-control block A is maintained, i.e., the predetermined servo-control setpoint position.

The neutral position is preferably disposed between the first extreme position and the second extreme position. In particular, the amplitude between the first extreme position and the second extreme position is e.g. centered on the neutral position.

The first command phase 104A also comprises the acquisition 110A of an evolution, during said asymmetric command 108A, of a force variable representative of an antagonistic force exerted in one of the servo-control blocks A, B during said asymmetric command 108A.

The acquisition 110A is e.g. implemented by the force sensor 58 of the sensor system 16.

The first command phase 104A then comprises the recording of said acquired evolution, e.g. in a memory 62 of the control unit 14.

By “evolution”, we mean the evolution over time of said force variable during the asymmetric command 108A. It is particularly the change over time of said force variable during the asymmetric command 108A.

Said acquired evolution corresponds in particular to the entire duration of the asymmetric command 108A.

The force variable is e.g. representative of the antagonistic stress force exerted in the first of the servo-control blocks B which causes the movement of the movable part 20.

During the asymmetric command 108A, the force variable is representative of an antagonistic stress force resulting from the asymmetric command 108A of the servo-control blocks A, B. More precisely, the antagonistic stress force results from a force conflict due to the different commands of the control surface 20 by the servo-control blocks A, B.

Indeed, in each servo-control block A, B, the controller 34 commands the servomotor 36 to compensate for the stress force exerted to respect the commanded closed-loop control during the asymmetric command 108A.

The acquisition 110A of the force variable thus allows for indirect access to the antagonistic stress force exerted, and thus to detect play, as described in more detail hereinbelow.

In the first hydraulic embodiment, the force variable is a function of the pressure of at least one of the chambers 50, 52, preferably a function of the measured pressures of the extension chamber 50 and the retraction chamber 52, and even more preferably a function of the difference between the pressures of the extension chamber 50 and the retraction chamber 52 of one of the servo-control blocks A, B.

For example, the force variable is a linear function of the difference between the pressures of the extension chamber 50 and the retraction chamber 52 of one of the servo-control blocks A, B.

The acquisition 110A is e.g. then implemented by the force sensor 58 formed by the assembly formed by the pressure sensor 56A of the extension chamber 50 and the pressure sensor 56B of the retraction chamber 52.

An example 110A of acquired evolution for the first phase 112A is illustrated on the right of FIG. 5. In this example, play is present in the mechanical chain 30S associated with the first servo-control block B.

The acquisition 110A of the force variable is implemented simultaneously with the asymmetric command 108A. As indicated above, the extreme positions of the displacement cycle of the asymmetric command 108A are determined by monitoring the acquired force variable.

The first command phase 104A also comprises, for each of a predetermined number of measurement points of the aerodynamic control system 12, the acquisition 112A of an evolution of a displacement of the measurement point during said asymmetric command 108A.

The first command phase 104A then comprises the recording of each acquired evolution, e.g. in a memory 62 of the control unit 14.

The measurement point is a point of the control surface 20, the displacement of said measurement point being then relative to the fixed part 18; or the measurement point is a point of the sliding element 40 of one of the servo-control blocks A, B, the displacement of said measurement point being then relative to the body 38.

In one embodiment, the predetermined number of measurement points of the aerodynamic control system 12 is greater than or equal to two.

The measurement points then comprise a point of the sliding element 40 of the first of the servo-control blocks B and a point of the sliding element 40 of the second of the servo-control blocks A.

The acquisition 112A of these measurement points is e.g. implemented from the position sensors 42 of the servo-control blocks A, B.

In one embodiment, the predetermined number of measurement points of the aerodynamic control system 12 is greater than or equal to four.

The measurement points then also comprise:
a first point of the control surface 20, the first point being disposed closer to the rod 46 of the first of the servo-control blocks B than to the rod 46 of the second of the servo-control blocks A, and
a second point of the control surface 20, the second point being disposed closer to the rod 46 of the second of the servo-control blocks A than to the rod 46 of the first of the servo-control blocks B.

The acquisition 112A of these measurement points is preferably implemented e.g. from the integrated displacement sensors 24A, 24B in the aerodynamic control system 12.

An example 112A of acquired evolutions for the first phase is illustrated on the right of FIG. 5.

The acquisition 112A of the displacement evolution is implemented simultaneously with the asymmetric command 108A and the acquisition 110A of the force variable.

The second command phase 104B also comprises the asymmetric command 108B of the servo-control blocks A, B.

The asymmetric command 108B of the second phase is inverted relative to the asymmetric command 108A of the first command phase 104A.

More precisely, during the asymmetric command 108B of the second phase 104B, the second of the servo-control blocks A is commanded like the first of the servo-control blocks B during the asymmetric command 108A of the first phase 104A, and the first of the servo-control blocks B is commanded like the second of the servo-control blocks A during the asymmetric command 108A of the first phase 104A.

Thereby, during the asymmetric command 108B of the second phase 104B, the second of the servo-control blocks A is commanded to cause a movement of the control surface 20 relative to the fixed part 18 like the first of the servo-control blocks B during the asymmetric command 108A of the first phase 104A, while the first of the servo-control blocks B is commanded differently like the second of the servo-control blocks A during the asymmetric command 108A of the first phase 104A.

The second command phase 104B also comprises the acquisition 110B of an evolution, during said asymmetric command 108B, of a force variable representative of an antagonistic force exerted in one of the servo-control blocks A, B during said asymmetric command 108B.

The force variable is e.g. then representative of the antagonistic force exerted in the second of the servo-control blocks A which causes the movement of the control surface 20.

The second command phase 104B then comprises the recording of the acquired evolution, e.g. in a memory 62 of the control unit 14.

An example 110B of acquired evolution for the second phase 10B is illustrated on the right of FIG. 6. This example corresponds to the same situation as for FIG. 5, i.e., play is present in the mechanical chain 30S associated with the first servo-control block B.

The acquisition 110B of the force variable is implemented simultaneously with the asymmetric command 108B. As indicated above, the extreme positions of the displacement cycle of the asymmetric command 108B are determined by monitoring the acquired force variable.

Furthermore, the second command phase 104B comprises, for each of the predetermined number of measurement points of the aerodynamic control system 12, the acquisition 112B of an evolution of a displacement of the measurement point during said asymmetric command 108B of the second phase 104B.

It is particularly the same measurement point(s) as in the first phase 104A.

The second command phase 104B then comprises the recording of each acquired evolution, e.g. in a memory 62 of the control unit 14.

An example 112B of acquired evolutions for the second phase 104B is illustrated on the right of FIG. 6.

The acquisition 112B of the displacement evolution is implemented simultaneously with the asymmetric command 108B and the acquisition 110B of the force variable.

The play detection phase 106 comprises the verification 114 of at least one detection condition based on said acquired evolution of the force variable, play being detected if the detection condition is met.

Preferably, the play detection phase 106 comprises, for each implemented command phase 104A, 104B, the verification 114 of at least one detection condition based on said acquired evolution of the force variable during the command phase 104A, 104B.

More precisely, the play detection phase 106 comprises, for each measurement point of each command phase 104A, 104B, the verification 114 of a detection condition associated with the measurement point and the command phase 104A, 104B.

In a preferred embodiment, for each measurement point of each command phase 104A, 104B, the verification 114 comprises the determination 116 of a displacement amplitude of said measurement point, reached during the acquired evolution of said displacement of the measurement point during the command phase 104A, 104B.

All positions of said measurement point, reached during the acquired evolution, are comprised in the determined displacement amplitude.

In a preferred embodiment, for each measurement point of each command phase 104A, 104B, the verification 114 also comprises the determination 118 of a reference amplitude associated with said measurement point.

The reference amplitude is determined at least based on the acquired evolution of the force variable.

The reference amplitude is advantageously determined from at least one reference value of the force variable representative of a predetermined antagonistic force exerted during the asymmetric command.

The predetermined antagonistic force is e.g. the maximum antagonistic force exerted during the asymmetric command.

The determination 118 of the reference amplitude preferably comprises the determination of at least two reference values of the force variable, the reference values being defined as the values reached by the variable at the first extreme position and at the second extreme position of the displacement cycle, the reference amplitude being determined from said reference values.

In other words, the reference values are associated with the extreme positions of the cycle and reflect a maximum antagonistic force exerted within the associated block.

In the preferred embodiment where the extreme positions of the cycle are determined by monitoring the force variable, the reference values preferably correspond to the values representative of the predetermined force threshold.

In the first hydraulic embodiment, the reference values of the force variable correspond e.g. to the pressure difference ΔP_{ST} associated with the extreme position of the cycle where the sliding element 40 is most extended, and to the pressure difference ΔP_{RT} associated with the extreme position of the cycle where the sliding element 40 is most retracted.

The reference amplitude is e.g. determined from the sum of the reference values ΔPA_{ST} and ΔPA_{RT}.

In the first hydraulic embodiment, where the force variable is homogeneous at a pressure, the reference amplitude is also determined based on the active surface area S of the rod 46 of the sliding element 40 of the servo-control block A, B associated with the force variable. The active surface area S corresponds to the surface area of the rod 46 on which the pressure is expressed.

In a preferred embodiment, the reference amplitude is also determined based on an equivalent reference stiffness associated with said measurement point and the command phase 104A, 104B, the equivalent reference stiffness corresponding to an absence of play.

Each equivalent reference stiffness is particularly stored in a memory 62 of the control unit 14 before the implementation of the play detection sequence 102, e.g. in the form of a matrix such as the one in the table hereinbelow:

TABLE 1
Example of equivalent reference stiffness matrix

| | | Equivalent reference stiffness K (e.g. in daN/°) | | | |
|---|---|---|---|---|---|
| | | Measurement | Measurement | Measurement | Measurement |
| | Force | point of the | point of the | point of the | point of the |
| | (e.g. | sliding | control | control | sliding |
| | ΔP*S) | element of | surface near | surface near | element of |
| | (in | block A | block A | block B | block B |
| | daN) | (FbkA) | (SSUA) | (SSUB) | (FBKB) |
| Command | F_{A} | KFbkA_{Amobile} | KSSUA_{Amobile} | KSSUB_{Amobile} | KFbkB_{Amobile} |
| phase: servo- | | | | | |
| control block A | | | | | |
| mobile and | | | | | |
| servo-control | | | | | |
| block B | | | | | |
| immobile | | | | | |
| Command | F_{B} | KFbkA_{Bmobile} | KSSUA_{Bmobile} | KSSUB_{Bmobile} | KFbkB_{Bmobile} |
| phase: servo- | | | | | |
| control block B | | | | | |
| mobile and | | | | | |
| servo-control | | | | | |
| block A | | | | | |
| immobile | | | | | |

Each equivalent reference stiffness has preferably been previously determined for an absence of play.

For example, each equivalent reference stiffness has been previously determined for an absence of play, following a preliminary parameterization phase 150 for a proven absence of play in the aerodynamic control system 12.

The preliminary parameterization phase 150 is e.g. implemented at the end of the manufacturing line of the aerodynamic control system 12, after verifying a proven absence of play.

The preliminary parameterization phase 150 preferably comprises the same command phases as the implemented detection sequence 102.

During the preliminary parameterization phase 150, for the preliminary command phase where the servo-control block B is mobile, the equivalent stiffnesses at the measurement points are e.g. determined according to the following relations:

$${KFbkB}_{B mobile} = \frac{\vert Δ {PB}_{S T} \vert + \vert Δ {PB}_{R T} \vert}{{XFbkB}_{S T} - {XFbkB}_{R T}} * S \qquad [ Math 1 ]$$

$${KSSUB}_{B m o b i l e} = \frac{\vert Δ {PB}_{S T} \vert + \vert Δ {PB}_{R T} \vert}{{XSSUB}_{S T} - {XSSUB}_{R T}} * S \qquad [ Math 2 ]$$

$${KFbkA}_{B m o b i l e} = \frac{\vert Δ {PB}_{S T} \vert + \vert Δ {PB}_{R T} \vert}{{XFbkA}_{S T} - {XFbkA}_{R T}} * S \qquad [ Math 3 ]$$

$${KSSUA}_{B m o b i l e} = \frac{\vert Δ {PB}_{S T} \vert + \vert Δ {PB}_{R T} \vert}{{XSSUA}_{S T} - {XSSUA}_{R T}} * S \qquad [ Math 4 ]$$

where ΔPB_{ST} is the pressure difference ΔP_{ST} in the chambers of block B, associated with the extreme position of the cycle where the sliding element 40 is most extended during the asymmetric command of the preliminary phase 150,
where ΔPB_{RT} is the pressure difference ΔP_{RT} in the chambers of block B, associated with the extreme position of the cycle where the sliding element 40 is most retracted during the asymmetric command of the preliminary phase 150,
where S is the cross-section of the rod of each sliding element 40 of block B, and
where the denominators of these relations correspond to the displacement amplitudes, during the preliminary phase 150 without play, of the measurement point of the sliding element 40 of block A (XFbkA), the second measurement point of the control surface near block A (XSSUA), the first measurement point of the control surface near block B (XSSUB), and the measurement point of the sliding element 40 of block B (XFbkB).

During the preliminary parameterization phase 150, for the preliminary command phase where the servo-control block A is mobile, the equivalent stiffnesses at the measurement points are determined e.g. in the same way.

The determination of such equivalent reference stiffnesses is advantageous, as it is not necessary to reproduce exactly the same displacement cycle for the detection sequence 102 as the one implemented for the preliminary phase 150.

This way of determining each equivalent reference stiffness is not limiting, and those skilled in the art will know how to adapt any other conceivable way. For example, the equivalent reference stiffness matrix is a universal matrix corresponding to an average over a predetermined number of aircraft.

In a preferred embodiment, for each measurement point of each command phase 104A, 104B, the verification 114 also comprises the comparison 120 of the displacement amplitude of said measurement point with the reference amplitude.

It is then possible to determine a matrix of differences ΔX between the determined displacement amplitudes and the reference amplitudes for each measurement point of each command phase 104A, 104B, in the form:

TABLE 2
Example of matrix of amplitude differences

| | | Differences ΔX between determined displacement | | | |
|---|---|---|---|---|---|
| | | amplitudes and reference amplitudes (e.g. in °) | | | |
| | | Measurement | Measurement | Measurement | Measurement |
| | Force | point of the | point of the | point of the | point of the |
| | (e.g. | sliding | control | control | sliding |
| | ΔP*S) | element of | surface near | surface near | element of |
| | (in | block A | block A | block B | block B |
| | daN) | (FbkA) | (SSUA) | (SSUB) | (FBKB) |
| Command | F_{A} | ΔXFbkA_{Amobile} | ΔXSSUA_{Amobile} | ΔXSSUB_{Amobile} | ΔXFbkB_{Amobile} |
| phase 104B: | | | | | |
| servo-control | | | | | |
| block A mobile | | | | | |
| and servo- | | | | | |
| control block B | | | | | |
| immobile | | | | | |
| Command | F_{B} | ΔXFbkA_{Bmobile} | ΔXSSUA_{Bmobile} | ΔXSSUB_{Bmobile} | ΔXFbkB_{Bmobile} |
| phase 104A: | | | | | |
| servo-control | | | | | |
| block B mobile | | | | | |
| and servo- | | | | | |
| control block A | | | | | |
| immobile | | | | | |

For each measurement point of each command phase 104A, 104B, the detection condition is then met at least if the difference between the displacement amplitude of said measurement point and the reference amplitude is greater than a predetermined play detection threshold.

The detection threshold corresponds e.g. to a regulatory threshold of maximum allowed play.

When the detection condition is met, the play detection phase 106 then preferably comprises the sending 122 of an alarm signal to an operator. The alarm is e.g. visual and/or auditory.

When the detection condition is met, the play detection phase 106 preferably comprises the determination 124 of a localization of the play in the mechanical chain 30N, 30S associated with one of the servo-control blocks A, B.

The localization of the play is determined from the comparison, for each measurement point of each command phase 104A, 104B, of the displacement amplitude with the reference amplitude.

In the example of FIGS. 5 and 6 with the presence of play in the servo-control block B, during the first phase where the servo-control block B is mobile and the servo-control block A is immobile, it will be found that the displacement amplitude XFbkB_{ST}-XFbkB_{RT} of the sliding element 40 of the servo-control block B (referenced 110A on the right of FIG. 5) is greater than the reference amplitude (referenced 150 on the left of FIG. 5). The displacement amplitudes of the two measurement points of the control surface 20 are equal to their respective reference amplitudes.

Furthermore, during the second phase where the servo-control block B is immobile and the servo-control block A is mobile, it will be found that the displacement amplitude XFbkA_{ST}-XFbkA_{RT} of the sliding element 40 of the servo-control block A, and the displacement amplitudes SSUB, SSUA of the two measurement points of the control surface 20 (referenced 112B on the right of FIG. 6) are greater than the respective reference amplitudes thereof (referenced 150 on the left of FIG. 6).

Following the detection of play, it is then possible to implement a conventional method, as described above, for precise measurement of the play that has been detected by the method 100 according to the present disclosure.

In another embodiment, the detection condition is met at least if said acquired evolution of the force variable presents a region where the force variable is representative of an antagonistic stress force exerted on one of the servo-control blocks A, B by the control surface 20 which is zero, during said asymmetric command 108A, 108B.

The detection condition is preferably met if the region presents an extent greater than a predetermined play detection threshold.

These regions are notably visible in FIGS. 5 and 6 and correspond to the plateaus where the pressure difference cancels out.

In the first hydraulic embodiment, the regions correspond to zero pressure differences between the chambers 50, 52, during the movement of the sliding element 40 of one of the servo-control blocks A, B.

Indeed, in case of play, these regions respectively correspond to a commanded movement of the sliding element 40 but without movement of the control surface 20, and thus without stress force resulting from the asymmetric command 108A, 108B.

Preferably, the detection condition is met at least if said acquired evolution presents, for each cycle, such a region.

In another embodiment, the force sensor comprises a strain gauge glued to an element of the servo-control block. The force variable is then determined from the strain gauge.

In a second non-illustrated embodiment, each servo-control block A, B is electric.

In the second electric embodiment, the servomotor 36 then preferably comprises a stator and a rotor and is configured for converting an electrical supply into rotation of the rotor relative to the stator to cause a movement of the sliding element 40 relative to the body 38.

The servomotor 36 is e.g. any type of electric motor known to a person skilled in the art.

The force variable is then e.g. an electrical variable of the servomotor 36, such as a current generated by the exerted antagonistic force.

Alternatively, the detection sequence 102 comprises only one command phase.

By means of the previously described features, it is possible to detect play in an aerodynamic control system 12 of an aircraft, without actuator removal, without specific tools, and by the operator of the aircraft themselves (i.e., without the need for a specialized engineer).

Moreover, it is possible to easily automate this method 100, as said method only uses sensors integrated into the aerodynamic control system 12 if necessary.

What is claimed is:

1. A method for detecting play in an aerodynamic control system, the aerodynamic control system comprising a fixed part, a control surface movable relative to the fixed part, and a servo-control, the servo-control comprising at least two redundant servo-control blocks, each servo-control block being configured for causing a movement of the control surface relative to the fixed part, the method comprising:
a play detection sequence comprising at least one command phase and a play detection phase,
the command phase comprising:
an asymmetric command of the servo-control blocks, during which a first of the servo-control blocks is commanded to cause a movement of the control surface relative to the fixed part, while a second of the servo-control blocks is commanded differently; and
acquisition of an evolution, during said asymmetric command, of a force variable representative of an antagonistic force exerted in one of the servo-control blocks during said asymmetric command;
the play detection phase comprising a verification of at least one play detection condition based on said acquired evolution, a play being detected if the detection condition is met.

2. The method according to claim 1, wherein, during the asymmetric command, the second of the servo-control blocks is commanded to maintain the control surface in position relative to the fixed part.

3. The method according to claim 1, wherein the command phase further comprises, for each of a predetermined number of measurement points of the aerodynamic control system, acquisition of at least one evolution of a displacement of the measurement point during said asymmetric command,
and, wherein the play detection phase comprises, for each measurement point, a verification of a detection condition associated with the measurement point, the verification comprising:
determining a displacement amplitude of said measurement point, reached during the acquired evolution of said displacement of the measurement point;
determining a reference amplitude associated with said measurement point, the reference amplitude being determined at least based on the acquired evolution of the force variable, and
comparing the displacement amplitude of said measurement point with the reference amplitude, the play detection condition being met at least if the difference between the displacement amplitude of said measurement point and the reference amplitude is greater than a predetermined play detection threshold.

4. The method according to claim 3, wherein the reference amplitude is determined from at least one reference value of the force variable, the at least one reference value being representative of a predetermined antagonistic force exerted during the asymmetric command.

5. The method according to claim 3, wherein the reference amplitude is also determined based on an equivalent reference stiffness associated with said measurement point, the equivalent reference stiffness corresponding to an absence of play.

6. The method according to claim 5, wherein the equivalent reference stiffness has been previously determined for an absence of play, following a preliminary parameterization phase for a proven absence of play in the aerodynamic control system.

7. The method according to claim 6, wherein the preliminary parameterization phase comprises the same command phases as the play detection sequence.

8. The method according to claim 1, wherein each servo-control block respectively comprises at least one servomotor, a body, and a sliding element relative to the body, the sliding element comprising a rod extending longitudinally to an end connected to the control surface; and, for each servo-control block, a controller configured for commanding the servomotor by closed-loop servo-control to cause a movement of the control surface relative to the fixed part by moving the sliding element relative to the body to a servo-control setpoint position.

9. The method according to claim 8, wherein the force variable depends on the closed-loop servo-control of the servomotor by the controller of the servo-control block during the asymmetric command.

10. The method according to claim 8, wherein, during the asymmetric command, the first of the servo-control blocks is commanded to cause a movement of the control surface relative to the fixed part by moving the sliding element relative to the body according to at least one cycle of extension and retraction of the sliding element relative to the body.

11. The method according to claim 10, wherein each cycle of extension and retraction comprises, from a neutral position, an extension or a retraction of the sliding element to a first extreme position, then a retraction or an extension to a second extreme position, then a return to the neutral position.

12. The method according to claim 11, wherein the neutral position corresponds to the position at which the sliding element of the second servo-control block is maintained, and/or the neutral position is disposed between the first extreme position and the second extreme position.

13. The method according to claim 11, wherein the determination of the reference amplitude comprises the determination of at least two reference values of the force variable, the reference values being defined as the values reached by a variable at the first extreme position and at the second extreme position of a displacement cycle, the reference amplitude being determined from said reference values.

14. The method according to claim 8, wherein the command phase further comprises, for each of a predetermined number of measurement points of the aerodynamic control system, acquisition of at least one evolution of a displacement of the measurement point during said asymmetric command,
wherein the play detection phase comprises, for each measurement point, a verification of a detection condition associated with the measurement point, the verification comprising:
determining a displacement amplitude of said measurement point, reached during an acquired evolution of said displacement of the measurement point;
determining a reference amplitude associated with said measurement point, the reference amplitude being determined at least based on the acquired evolution of the force variable, and
comparing the displacement amplitude of said measurement point with the reference amplitude, the play detection condition being met at least if the difference between the displacement amplitude of said measurement point and the reference amplitude is greater than a predetermined play detection threshold,
and wherein the measurement point of the aerodynamic control system is a point of the control surface, the displacement of said measurement point being relative to the fixed part; or the measurement point of the aerodynamic control system is a point of the sliding element of one of the servo-control blocks, the displacement of said measurement point being relative to the body.

15. The method according to claim 14, wherein the predetermined number of measurement points of the aerodynamic control system is greater than or equal to four, the measurement points comprising:
a point of the sliding element of the first of the servo-control blocks;
a point of the sliding element of the second of the servo-control blocks;
a first point of the control surface, the first point being disposed closer to the rod of the first of the servo-control blocks than to the rod of the second of the servo-control blocks; and
a second point of the control surface, the second point being disposed closer to the rod of the second of the servo-control blocks than to the rod of the first of the servo-control blocks.

16. The method according to claim 1, wherein said command phase is a first command phase, the play detection sequence also comprising a second inverted command phase, comprising:
the asymmetric command of the servo-control blocks, during which the second of the servo-control blocks is commanded like the first of the servo-control blocks during the asymmetric command of the first phase, and the first of the servo-control blocks is commanded like the second of the servo-control blocks during the asymmetric command of the first phase;
the acquisition of an evolution, during said asymmetric command, of a force variable representative of an antagonistic force exerted in one of the servo-control blocks during said asymmetric command;
and, wherein the play detection phase comprises, for each implemented command phase, a verification of at least one detection condition based on said acquired evolution during the command phase.

17. The method according to claim 1, wherein each servo-control block respectively comprises at least one servomotor, a body, and a sliding element relative to the body, the sliding element comprising:
a rod extending longitudinally to an end connected to the control surface; and,
for each servo-control block, a controller being configured for commanding the servomotor by closed-loop servo-control causing a movement of the control surface relative to the fixed part by moving the sliding element relative to the body to a servo-control setpoint position,
wherein each servo-control block is hydraulic, and, for each servo-control block, the body defines an internal space and the sliding element also comprises a control piston disposed in the internal space, the internal space being shared by the control piston between an extension chamber and a retraction chamber, the servomotor of each servo-control block comprising a hydraulic distributor to route a fluid from a fluid source to the extension chamber and/or to the retraction chamber, the controller being configured for commanding the hydraulic distributor of the servomotor to cause a movement of the sliding element relative to the body,
and, wherein the force variable depends on the closed-loop servo-control of the servomotor by the controller of the servo-control block during the asymmetric command, the force variable being a function of measured pressures of the extension chamber and the retraction chamber of the servo-control block.

18. The method according to claim 17, wherein the detection condition is met at least if said acquired evolution of the force variable presents a region where the force variable is representative of a stress force exerted on one of the servo-control blocks by the control surface which is zero during said asymmetric command.

19. The method according to claim 18, wherein the region has an extent greater than a predetermined play detection threshold.

20. A detection system for play in an aerodynamic control system, the aerodynamic control system comprising:
a fixed part;
a control surface movable relative to the fixed part; and
a servo-control, the servo-control comprising two redundant servo-control blocks, each servo-control block being configured for causing a movement of the control surface relative to the fixed part;
wherein the detection system comprises a control unit configured to independently command each servo-control block and to implement a play detection sequence comprising at least one command phase and a play detection phase,
the command phase comprising:
an asymmetric command of the servo-control blocks, during which a first of the servo-control blocks is commanded causing a movement of the control surface relative to the fixed part, while a second of the servo-control blocks is commanded differently; and
an acquisition of an evolution, during said asymmetric command, of a force variable representative of an antagonistic force exerted in one of the servo-control blocks during said asymmetric command;
the play detection phase comprising verification of at least one detection condition based on said acquired evolution, a play being detected if the detection condition is met.
